(19) United States
(12) Patent Application Publication
(10) Pub. No.: US 2007/0271585 A1
(43) Pub. Date: Nov. 22, 2007

(54) Monitoring-Image Transmission Device, Monitoring-Image Transmission Method, Computer Readable Medium, And Computer Data Signal

(75) Inventors: Shinya Taguchi, Kanagawa (JP); Eisuke Kanno, Kanagawa (JP)

Correspondence Address: GAUTHIER & CONNORS, LLP, 225 FRANKLIN STREET, SUITE 2300, BOSTON, MA, 02110, US

(73) Assignee: FUJI XEROX CO., LTD., Tokyo (JP)

(21) Appl. No.: 11/561,461

(22) Filed: Nov. 20, 2006

(30) Foreign Application Priority Data
May 17, 2006 (JP) 2006-138127

(51) Int. Cl. H04N 7/173

(52) U.S. Cl. 725/105

(57) ABSTRACT

A monitoring-image transmission device includes an image-data acquisition unit that acquires image data to be displayed on a screen of a display device from a screen-image-displaying memory device which stores the image data; and an image-data transmission unit that sends the image data acquired to a monitor device which remotely monitors a displayed state of a screen image in the display device.

### PRIORITY INFORMATION

This application claims priority to Japanese Patent Application No. 2006-138127, filed on May 17, 2006.

### BACKGROUND

1. Technical Field

The present invention relates to a monitoring-image transmission device, a monitoring-image transmission method, a computer readable medium, and a computer data signal.

2. Related Art

There is available a technique for remotely monitoring the displayed state of a display device.

### SUMMARY

According to one aspect of the present invention, there is provided, a monitoring-image transmission device having: an image-data acquisition unit that acquires image data to be displayed on a screen of a display device from a screen-image-displaying memory device which stores the image data; and an image-data transmission unit that sends the image data acquired to a monitor device which remotely monitors a displayed state of a screen image in the display device.

### BRIEF DESCRIPTION OF THE DRAWINGS

Exemplary embodiment of the present invention will be described in detail based on the following figures, wherein:

FIG. 1 is a block diagram showing the overall structure of a content display system containing a monitoring-image transmission device according to an exemplary embodiment;

FIG. 2 is a block diagram showing a structure of a content display terminal and a distribution center;

FIG. 3 is a diagram showing one example of circulation set data;

FIG. 4 is a flowchart of an operational procedure for displaying the content in the content display system according to the exemplary embodiment;

FIG. 5 is a diagram showing a state in which the content is displayed in a circulating manner;

FIG. 6 is a flowchart of an operational procedure for monitoring the displayed state of a screen image in the content display system according to the exemplary embodiment; and

FIG. 7 is a diagram showing one example of a schedule table.

### DETAILED DESCRIPTION

In the following, an exemplary embodiment of the present invention will be described with reference to the accompanying drawings.

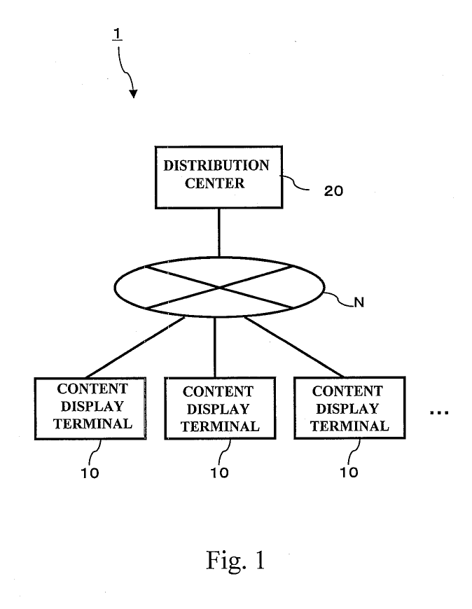

FIG. 1 is a block diagram showing the overall structure of a content display system 1 which includes a monitoring-image transmission device according to an exemplary embodiment. In FIG. 1, the content display system 1 has one or more content display terminals 10 and a distribution center 20. The respective content display terminals 10 and the distribution center 20 are mutually connected via a network N such as the Internet or the like.

The content display terminal 10 is a device for displaying content. In this exemplary embodiment, the content display terminal 10 is an electronic board device which is installed at the entrance of a store or a company, for displaying content, such as advertisement, information for employees, and so forth. As examples of content, character information, a still image, a motion image, and so forth can be mentioned. In this exemplary embodiment, the content display terminal 10 functions also as a monitoring-image transmission device, as described below.

The distribution center 20 is a device for distributing content to the content display terminal 10. In this exemplary embodiment, the distribution center 20 functions also as a monitor device for remotely monitoring the displayed state of a screen image in the content display terminal 10. In this exemplary embodiment, the distribution center 20 is a server device which is constructed from one or more computers.

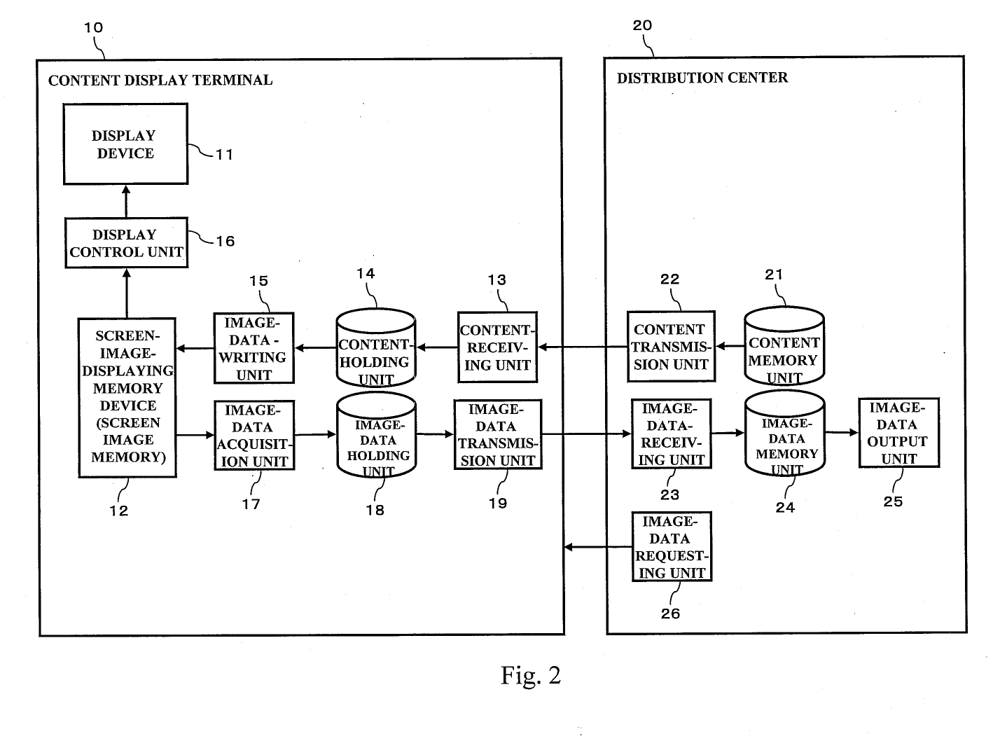

FIG. 2 is a block diagram showing a structure of the content display terminal 10 and the distribution center 20. In the following, by reference to FIG. 2, a structure of the content display terminal 10 and the distribution center 20 will be described.

In FIG. 2, the content display terminal 10 has a display device 11, a screen-image-displaying memory device 12, a content-receiving unit 13, a content-holding unit 14, an image-data-writing unit 15, a display control unit 16, an image-data acquisition unit 17, an image-data-holding unit 18, and an image-data transmission unit 19.

The display device 11 is a device for displaying an image, and, may be, for example, a CRT (Cathode Ray Tube) display, a liquid crystal display, a plasma display, or the like.

The screen-image-displaying memory device 12 holds image data to be displayed on the screen of the display device 11, and, in this exemplary embodiment, is a screen-image-displaying memory for holding image data; that is, a VRAM (Video Random Access Memory). In the description below, the screen-image-displaying memory device 12 is discretionally referred to as a “screen image memory 12.” The screen image memory 12 is realized by, for example, a part of a main memory, a dedicated memory mounted to a video card, or the like.

The content-receiving unit 13 receives content and a schedule to display the content, or a display schedule, from the distribution center 20.

The content-holding unit 14 holds the content and the display schedule thereof received by the content-receiving unit 13, and is realized by a memory device such as a RAM (Random Access Memory), a hard disk, or the like.

The image-data-writing unit 15, referring to the content-holding unit 14, writes image data into the screen image memory 12 so that the content held in the content-holding unit 14 is displayed on the display device 11 in accordance with the display schedule.

The display control unit 16 effects control so as to display, on the screen of the display device 11, an image which is expressed on the basis of the image data held in the screen image memory 12.

The image-data acquisition unit 17 acquires the image data from the screen image memory 12. In this exemplary embodiment, the image-data acquisition unit 17 acquires the image data from the screen image memory 12 in accordance with the switching of the images displayed on the screen of the display device 11 or the display schedule of the content. Alternatively, the image data acquisition unit 17 acquires the image data from the screen image memory 12 in response to a request sent from the distribution center 20 on the basis of the user's instruction. It should be noted that the timing at which the image-data acquisition unit 17 acquires the image data is not limited to the timing described above, and may be desirably set. For example, the image-data acquisition unit 17 may acquire the image data at a predetermined time interval.

The image-data-holding unit 18 holds the image data acquired by the image-data acquisition unit 17, and is realized by a memory device such as a RAM, a hard disk, or the like.

The image-data transmission unit 19 sends the image data held in the image-data-holding unit 18 to the distribution center 20.

It should be noted that the content display terminal 10 having the above-described structure may physically be a single device or multiple devices connected to one another via a cable or the like. For example, the content display terminal 10 may be constructed from a display device 11 and a computer having members 12 through 19 other than the display device 11.

The above-described content-receiving unit 13, the image-data-writing unit 15, the display control unit 16, the image-data acquisition unit 17, and the image-data transmission unit 19 are realized by reading a program recorded in a recording medium, such as a ROM (Read Only Memory), a hard disk, or the like to the main memory, and executing the read program by the CPU (Central Processing Unit). Such a program can be distributed in the form of being recording in a desired recording medium such as a CD-ROM or the like, or via a network. Such a program may be a software program which operates in a general purpose OS (Operating System), for example. A portion of or all of the above-described function blocks may be realized by means of any other structure, such as a dedicated hardware device, or the like.

In FIG. 2, the distribution center 20 has a content memory unit 21, a content transmission unit 22, an image-data-receiving unit 23, an image-data memory unit 24, an image-data output unit 25, and an image-data-requesting unit 26.

The content memory unit 21 stores content and a display schedule thereof, and is realized by use of, for example, a memory device such as a hard disk or the like.

The content transmission unit 22 sends the content and the display schedule thereof, both recorded in the content memory unit 21, to the content display terminal 10.

The image-data-receiving unit 23 receives the image data sent from the image-data transmission unit 19 of the content display terminal 10.

The image-data memory unit 24 stores the image data received by the image-data-receiving unit 23, and is realized by, for example, a memory device such as a RAM, a hard disk, or the like.

The image-data output unit 25 outputs the image data stored in the image-data memory unit 24 to an output device (not shown) (a display or the like) of the distribution center 20.

The image-data-requesting unit 26 requests the content display terminal 10 to acquire the image data, on the basis of the user's instruction.

It should be noted that the above-described content transmission unit 22, the image-data-receiving unit 23, the image-data output unit 25, and the image-data-requesting unit 26 are realized by reading a program stored in, for example, the recording medium, such as a ROM, a hard disk, or the like, to the main memory, and executing the read program by the CPU. Such a program can be distributed in the form of being recording in a desired recording medium, such as a CD-ROM or the like, or via a network. Such a program is, for example, a software program which operates in a general purpose OS (Operating System). A portion of or all of the function blocks may be realized by means of any other structure, such as a dedicated hardware device, or the like.

Also, as a method used for communication between the above-described content display terminal 10 and the distribution center 20, a communication method using an IP (Internet Protocol), for example, may be available. In particular, when an IP communication which uses an HTTP (HyperText Transfer Protocol) is employed, preferable communication can be carried out between the content display terminal 10 and the distribution center 20 even if a firewall is established between them. It should be noted that, obviously, other communication methods may be employed for the communication between the content display terminal 10 and the distribution center 20.

In the above-described content display terminal 10 and the distribution center 20, the image data acquired from the screen image memory 12 are managed in a desired manner, for example, as an image file.

In the following, an operation of the content display system 1 having the above-described structure will be described in connection with an operation for displaying a content and with an operation for monitoring the displayed state of a screen image, respectively. It should be noted that it is assumed here that circulation set data which contain multiple contents to be repetitively displayed in the content display terminal 10 and the display schedule thereof are registered in advance in the content memory unit 21 of the distribution center 20.

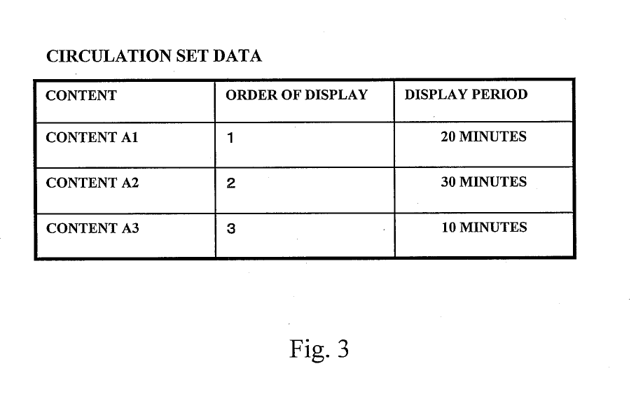

FIG. 3 shows one example of the circulation set data. In the example of FIG. 3, the circulation set data contain multiple contents to be repetitively displayed in the content display terminal 10 (for example, a still image file, a motion image file, or the like), an order to display the respective contents, and the display periods of time for the respective contents.

### [Operation to Display Content]

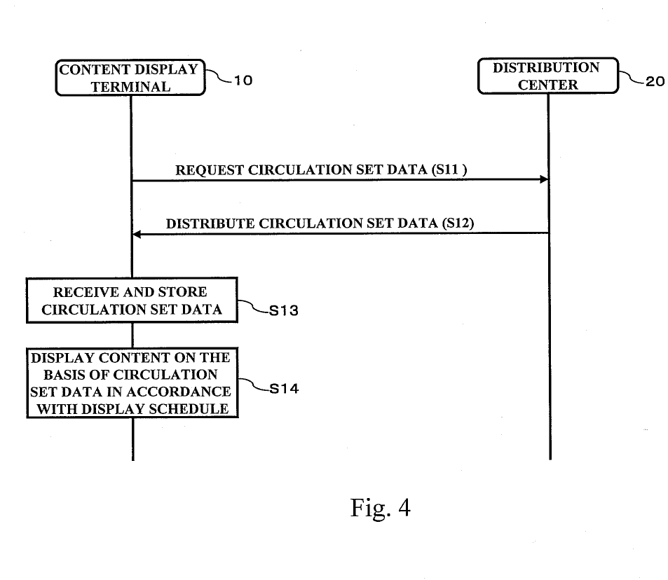

FIG. 4 is a flowchart of an operational procedure for displaying a content by the content display system 1 according to this exemplary embodiment. In the following, by reference to FIG. 4, a content-displaying operation to be carried out by the content display system 1 will be described.

By reference to FIG. 4, in the content display terminal 10, the content-receiving unit 13 sends a request for circulation set data to the distribution center 20 at a predetermined timing such as upon activation of the content display terminal 10, at a predetermined time interval, or the like (S11).

In the distribution center 20, the content transmission unit 22 receives the request for circulation set data from the content display terminal 10, and distributes the circulation set data registered in the content memory unit 21 to the content display terminal 10 (S12).

In the content display terminal 10, the content-receiving unit 13 receives the circulation set data distributed from the distribution center 20, and stores the same in the content-holding unit 14 (S13).

The image-data-writing unit 15 and the display control unit 16 operate cooperatively to cause the display device 11 to display the content in accordance with the display schedule on the basis of the circulation set data stored in the content-holding unit 14 (S14).

Specifically, the image-data-writing unit 15 writes the image data into the screen image memory 12 such that multiple contents contained in the circulation set data are repetitively displayed in the order of display which is defined by the circulation set data, for a display period of time which is also defined by the circulation set data. The display control unit 16 causes the display device 11 to display the image on the basis of the image data written in the screen image memory 12.

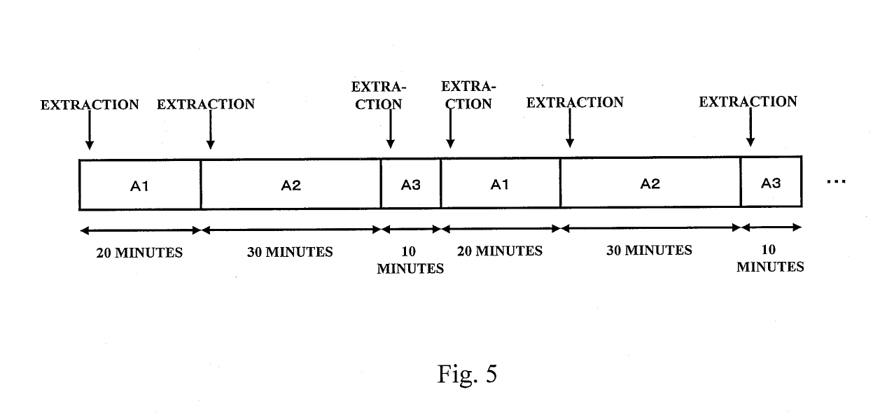

With the above, as for the circulation set data such as is shown in FIG. 3, for example, the contents A1, A2, A3 are displayed in the circulating manner as A1→A2→A3→A1→A2→A3→ . . . , as shown in FIG. 5.

### [Operation to Monitor Displayed State of Screen Image]

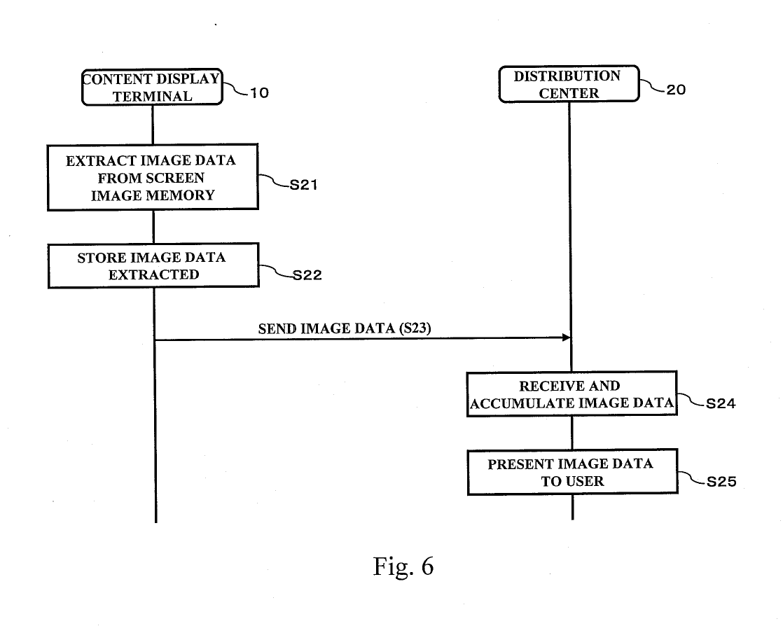

FIG. 6 is a flowchart of an operational procedure for monitoring the displayed state of a screen image in the content display system 1 according to this exemplary embodiment. In the following, referring to FIG. 6, an operation to monitor the displayed state of a screen image in the content display system 1 will be described.

Referring to FIG. 6, in the content display terminal 10, the image-data acquisition unit 17 extracts the image data from the screen image memory 12 at a predetermined timing (S21)

In this exemplary embodiment, the image-data acquisition unit 17 extracts the image data from the screen image memory 12 at a timing at which displaying of the content is completed, as indicated by the arrow in FIG. 5; that is, a timing which is in synchronism with the content display schedule.

In one example, when a process to switch the content to be written into the screen image memory 12 is completed, the image-data-writing unit 15 notifies the image data acquisition unit 17 of the completion of the switching process, and the image-data acquisition unit 17, upon receipt of the notice, extracts the image data.

In another example, a timing at which to switch the contents is determined on the basis of the display schedule held in the content-holding unit 14, and the image data are extracted on the basis of that timing.

Also, in this exemplary embodiment, the image-data acquisition unit 17 extracts the image data from the screen image memory 12 upon receipt of a request from the distribution center 20. Specifically, upon receipt of a request to acquire image data, which is from the user (for example, a system manager), the image-data-requesting unit 26 of the distribution center 20 sends an image data acquisition request to the image-data acquisition unit 17, and the image-data acquisition unit 17, upon receipt of the image-data acquisition request, extracts the image data.

Thereafter, the image-data acquisition unit 17 stores the extracted image data in the image-data-holding unit 18 (S22).

The image-data transmission unit 19 sends, as a monitoring image, the image data held in the image-data-holding unit 18 to the distribution center 20 at a predetermined timing (S23). The above-described predetermined timing may be desirably set. For example, the image-data transmission unit 19 may send the image data every time the image data is extracted, or may collectively send at a desired timing. For example, the image-data transmission unit 19 may collectively send the image data at a predetermined interval or when the image data held in the image-data holding unit 18 amount to a predetermined volume. In this exemplary embodiment, as for the image data extracted in response to the image-data acquisition request, the image-data transmission unit 19 sends the image data immediately after the extraction.

In the distribution center 20, the image-data-receiving unit 23 receives the above-described image data from the image-data transmission unit 19, and accumulates the image data as a monitoring image in the image-data memory unit 24 (S24).

The image-data output unit 25 presents the image data accumulated in the image-data memory unit 24 to the user of the distribution center 20 (for example, a system manager) at a predetermined timing (S25). For example, the image-data output unit 25 displays the image data on the screen of the display device (not shown). The above-described predetermined timing may be desirably set. For example, the image-data output unit 25 may output the image data immediately after the receipt of the image data from the content display terminal 10 or in response to the user's instruction. In this exemplary embodiment, as for the image data extracted in response to the image-data acquisition request, the image-data output unit 25 presents the image data to the user immediately after the receipt of the image data.

In the distribution center 20, the user can monitor the displayed state of the content in the content display terminal 10 by viewing the monitoring image presented as described above, and thus can determine if the display is normal or abnormal. Here, as examples of an abnormal display, there may be mentioned an abnormal aspect ratio, display of an error screen image, and display of a screen image of an application in the content display terminal 10 (for example, a virus scan screen image of security software).

It should be noted that, although a case is described in the above in which a single set of circulation set data is registered in the content memory unit 21 of the distribution center 20, multiple sets of circulation set data may be registered.

In the following, an exemplary operation for a case in which multiple sets of circulation set data are registered will be described.

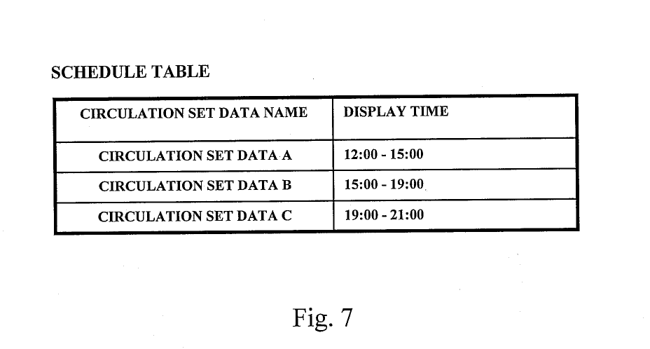

In the content memory unit 21, multiple sets of circulation set data are registered. The content memory unit 21 has a schedule table in which a display schedule of the circulation set data is registered. Specifically, in the schedule table, as shown in FIG. 7, for every set of circulation set data, identification information of the circulation set data set and a period of time to display each content relevant to the circulation set data are registered in association with each other.

At the time of activation, the content display terminal 10 sends a request for circulation set data to the distribution center 20.

Upon receipt of the request for circulation set data, the distribution center 20 specifies the circulation set data corresponding to the present time and also specifies the next time at which to switch the circulation set data, while referring to the schedule table. Then, the distribution center 20 distributes the above-described specified circulation set data to the content display terminal 10, and notifies the specified time for switching. For example, suppose that the schedule table is such as is shown in FIG. 7 and the present time is 13:00, the distribution center 20 distributes the circulation set data A and notifies the switching time of 15:00.

The content display terminal 10 receives the circulation set data and the switching time from the content transmission unit 22, and continues displaying of the multiple contents contained in the circulation set data in a circulating manner until arrival of the switching time. Upon arrival of the switching time, a request for circulation set data is sent to the distribution center 20.

Similar to the above, in response to the request for circulation set data, the distribution center 20 distributes the circulation set data to the content display terminal 10 and notifies the same of the switching time.

Thereafter, a similar process is repeated. With the above, the circulation set data are distributed to the content display terminal 10 in accordance with the schedule table.

It should be noted that although an example is described in the above in which the distribution center 20 notifies the switching time, notification of the switching time may be omitted. In this case, for example, the content display terminal 10 may send a request for circulation set data regularly in a relatively short cycle.

Also, although an arrangement is described in the above in which the distribution center 20 distributes the circulation set data in response to a request from the content display terminal 10, the distribution center 20 may autonomously distribute the circulation set data to the content display terminal 10. In this case, the distribution center 20 may distribute the circulation set data regularly or at a timing at which to switch the circulation set data.

Alternatively, there may also be applied an arrangement in which the distribution center 20 selects an appropriate content on the basis of the schedule table and the circulation set data and distributes the selected content to the content display terminal 10, and the content display terminal 10 displays the content. In this structure, the distribution center 20 may distribute the content at a timing at which to switch display of the content.

Still alternatively, there is also applicable an arrangement in which the distribution center 20 distributes the schedule table and all circulation set data to the content display terminal 10, so that the content display terminal 10 selects and displays an appropriate content on the basis of the schedule table and all circulation set data. In this arrangement, when the schedule table and/or the circulation set data are updated, the distribution center 20 may distribute the updated data.

Further alternatively, although an arrangement is described in the above in which the content is displayed in a circulating manner, the content is not necessarily displayed in a circulating manner. For example, the distribution center 20 may distribute multiple contents and display schedules thereof (for example, a period of time to display each content) to the content display terminal 10, and the content display terminal 10 displays the contents while switching the contents in accordance with the display schedule.

Yet further alternatively, although an arrangement is described in the above in which the image data are acquired immediately after the switching of the contents as an arrangement in which the image data are acquired in accordance with the switching of contents, the arrangement is not limited thereto, so long as the image data are acquired at least once during a period from a timing at which the content is switched to a next timing at which the content is switched.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The exemplary embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

For example, the distribution center 20 may determine whether or not the content is displayed as scheduled, on the basis of the image data sent from the content display terminal 10, and present the result of the determination to the user.

In addition to the image data, the content display terminal 10 may send history data, such as a log file or the like, as monitoring data, to the distribution center 20. History data may include, for example, history of operation carried out by the user in relation to the content display terminal 10, or the like. A user's operation in relation to the content display terminal 10 may include, for example, an operation to prolong display of a content, an operation to select and display a desired content from among the multiple contents contained in the circulation set data, an operation to print a content, or the like. In this case, the distribution center 20 may determine whether or not the content is displayed as scheduled on the basis of the image data and the history data provided by the content display terminal 10, and present the result of the determination to the user.

What is claimed is:

1. A monitoring-image transmission device, comprising:
an image-data acquisition unit that acquires image data to be displayed on a screen of a display device from a screen-image-displaying memory device which stores the image data; and
an image-data transmission unit that sends the image data acquired to a monitor device which remotely monitors a displayed state of a screen image in the display device.

2. The monitoring-image transmission device according to claim 1, wherein the image-data acquisition unit acquires the image data in accordance with switching of contents displayed on the screen of the display device.

3. The monitoring-image transmission device according to claim 1, wherein the image-data acquisition unit acquires the image data in response to a request from the monitor device on the basis of a user's instruction.

4. The monitoring-image transmission device according to claim 2, wherein the image-data acquisition unit acquires the image data in response to a request from the monitor device on the basis of a user's instruction.

5. A method for enabling remote monitoring of a displayed state in a display device, comprising:
acquiring image data to be displayed on a screen of the display device from a screen-image-displaying memory device which stores the image data; and
transmitting the image data acquired to a monitor device which remotely monitors a displayed state of a screen image in the display device.

6. The method according to claim 5, wherein the image data are acquired in accordance with switching of contents displayed on the screen of the display device.

7. The method according to claim 5, wherein the image data are acquired in response to a request from the monitor device on the basis of a user's instruction.

8. The method according to claim 6, wherein the image data are acquired in response to a request from the monitor device on the basis of a user's instruction.

9. A computer readable medium storing a program causing a computer to execute a process for enabling remote monitoring of a displayed state in a display device, the process comprising:
acquiring image data to be displayed on a screen of the display device from a screen-image-displaying memory device which stores the image data; and
transmitting the image data acquired to a monitor device which remotely monitors a displayed state of a screen image on the display device.

10. The computer readable medium according to claim 9, wherein the image data are acquired in accordance with switching of contents displayed on the screen of the display device.

11. The computer readable medium according to claim 9, wherein the image data are acquired in response to a request from the monitor device on the basis of a user's instruction.

12. The computer readable medium according to claim 10, wherein the image data are acquired in response to a request from the monitor device on the basis of a user's instruction.

13. A computer data signal embodied in a carrier wave for enabling a computer to perform a process for enabling remote monitoring of a displayed state in a display device, the process comprising:
acquiring image data to be displayed on a screen of the display device from a screen-image-displaying memory device which stores the image data; and
transmitting the image data acquired to a monitor device which remotely monitors a displayed state of a screen image in the display device.

14. The computer data signal according to claim 13, wherein the image data are acquired in accordance with switching of contents displayed on the screen of the display device.

15. The computer data signal according to claim 13, wherein the image data are acquired in response to a request from the monitor device on the basis of a user's instruction.

16. The computer data signal according to claim 14, wherein the image data are acquired in response to a request from the monitor device on the basis of a user's instruction.
